(19) United States
(12) Patent Application Publication
(10) Pub. No.: US 2002/0081011 A1
(43) Pub. Date: Jun. 27, 2002

(54) Method and apparatus for cutting out chest area from image formed with belt-shape area

(76) Inventor: Toshifumi Okada, Amagasaki-shi (JP)

Correspondence Address: WENDEROTH, LIND & PONACK, L.L.P., 2033 K STREET N. W., SUITE 800, WASHINGTON, DC, 20006-1021, US

(21) Appl. No.: 09/967,924

(22) Filed: Oct. 2, 2001

(30) Foreign Application Priority Data
Dec. 22, 2000 (JP) 2000-389975

(51) Int. Cl. G06K 9/00

(52) U.S. Cl. 382/132; 382/282

(57) ABSTRACT

A chest image area of a chest radiograph formed with a belt-shape area is cut out by searching a region of interest (ROI) from a central portion of an image along and towards vertical directions, calculating a pixel average value of the ROI and a variation thereof, detecting a belt area boundary portion between the chest image area and a belt-shape area in accordance with the variation of the pixel average so as to obtain vertically upper and lower side belt area boundary portions, and cutting out an image data, between the detected vertically upper and lower side belt area boundary portions, as a chest area data.

### BACKGROUND OF THE INVENTION

The present invention relates to a method and apparatus for cutting out a designated area such as a chest of a person from an image formed with a belt-shape area, more particularly, capable of automatically removing a blank area such as upper and/or lower belt-shape area included in an image at a time when the image is digitized in a technical field of a computer analysis of a digital image of such as chest radiograph, for example.

In such technical field, FIG. 15 shows one example of an image (photograph), in which character A shows an upper side belt-shape area, character B is a chest image area and character C is a lower side belt-shape area. Further, character D is an upper side belt area boundary (belt boundary portion) and character E is a lower side belt area boundary (belt boundary portion). The upper and lower side belt-shape areas A and C are blank areas which are added at a time of outputting an image on a film and in which patient (personal) information, photographing time (year, month, day, hour, etc.) and the like may be described. A film side blank area F may be included to this image including the belt-shape areas. This film side blank area F is an artifact (blank area) included in the image data when the film is digitized by a film digitizer, and in a prior art, the removal of the belt-shape area(s) from the image including the belt-shape areas in which the film including the belt-shape areas is digitized by utilizing the digitizer has been manually made or through designation of belt boundary portion.

As mentioned above, in the prior art, when the removal of the belt-shape area is performed manually, much time and labour are required for an operator, thus being inconvenient. On the other hand, when the removal thereof is performed through the designation of the belt boundary portion, it will be further required to change set values or like in a case where a belt-shape area to be now treated is different from a belt-shape area of an image which has been treated till that time.

### SUMMARY OF THE INVENTION

An object of the present invention is to substantially eliminate defects or drawbacks encountered in the prior art mentioned above and to provide method and apparatus for automatically detecting a belt boundary area (portion) in an image including belt-shape area and cutting out a designated area image such as chest image area of a person from the image including the belt-shape area.

This and other object can be achieved according to the present invention by providing, in one aspect, a method of cutting out a designated area from an image formed with a belt-shape area, comprising the steps of:

searching a region of interest (ROI) from substantially a central portion of an image towards vertical directions;

calculating a pixel average of the ROI and a variation thereof;

detecting a belt area boundary portion between the designated area and a belt-shape area in accordance with the variation of the pixel average so as to obtain vertically upper and lower side belt area boundary portions; and

cutting out an image data, between the detected vertically upper and lower side belt area boundary portions, as a designated area data.

In a preferred example of this aspect, the method further comprises the steps of calculating a variance of the ROI and detecting a blank portion of the image formed with the belt-shape area in accordance with the variance and wherein a position of the blank portion is processed as either one of the upper and lower side belt area boundary portions.

The designated area is preferably a chest area of a person. In another aspect of the present invention, there is provided an apparatus for cutting out a designated area from an image formed with a belt-shape area, comprising:

an image data storing section for storing a chest radiographdata of a designated area of a person;

a read-in section for reading the image data from the image data storing section;

a belt area boundary search section including at least one of upper and lower side belt area boundary search sections for detecting a belt area boundary portion between the designated area and a belt-shape area;

a cut-out section for cutting out an image data as a designated area data from an information of an image data of the belt area boundary portion from the belt area boundary search section; and

a processing section for processing the image data of the cutout designated area.

In a preferred example of this aspect, the belt area boundary portion search section including a sensor for detecting a blank portion of the image formed with the belt-shape area. The detection of the blank portion is performed in accordance with a variance of a region of interest (ROI).

The designated area is a chest area of a person. The belt area boundary portion search is performed in accordance with a variation of a pixel average of a region of interest (ROI).

The apparatus may further comprise an image display section for displaying a processed image from the image processing section.

According to the subject features of the present invention described above, the belt area boundary portion can be automatically detected and the designated area such as chest image area can be automatically cut out. Thus, manual working or operation can be remarkably made easy and reduced, and time and labour therefor can be also made reduced.

Furthermore, the belt-shape area and/or blank portion other than a film portion can be effectively removed to thereby surely cut out the chest image area as designated area.

The nature and further characteristic features of the present invention will be made more clear from the following descriptions made with reference to the accompanying drawings.

### BRIEF DESCRIPTION OF THE DRAWINGS

In the accompanying drawings:

FIG. 1 is a system diagram illustrating an apparatus for cutting out a chest area image portion from an image formed with a belt-shape area, according to an embodiment of the present invention;

FIG. 2 is a flowchart representing a method of cutting out a chest area image portion from an image formed with a belt-shape area, according to an embodiment of the present invention;

FIG. 3 shows several patterns of a belt area of the image, to which the present invention is applicable;

FIG. 4 is a view for an explanation of searching a belt area boundary;

FIG. 5 is a view showing a region at which the belt area boundary and a neck portion are contacted to each other;

FIG. 6 is a view for explaining calculation of a variation and a variance;

FIG. 7 is a view for explaining the cut-out of the chest area image from an image including belt-shape areas;

FIG. 8 is a view showing a search region (area) including the belt area boundary;

FIG. 9 is a graph showing a transition of pixel average near the belt area boundary;

FIG. 10 is a view showing collection of a variation data of the pixel average;

FIG. 11 shows one example of a histogram prepared from the collected variation data;

FIG. 12 is a moduled photograph of an image including belt-shape area before actually cutting out the chest image area;

FIG. 13 is a moduled photograph showing a discrimination result through searching of the belt area boundary position;

FIG. 14 is a moduled photograph of the cheat image area after the cut-out thereof; and

FIG. 15 is a moduled photograph including belt-shape areas.

### DESCRIPTION OF THE PREFERRED EMBODIMENT

A preferred embodiment of the present invention will be described hereunder with reference to the accompanying drawings.

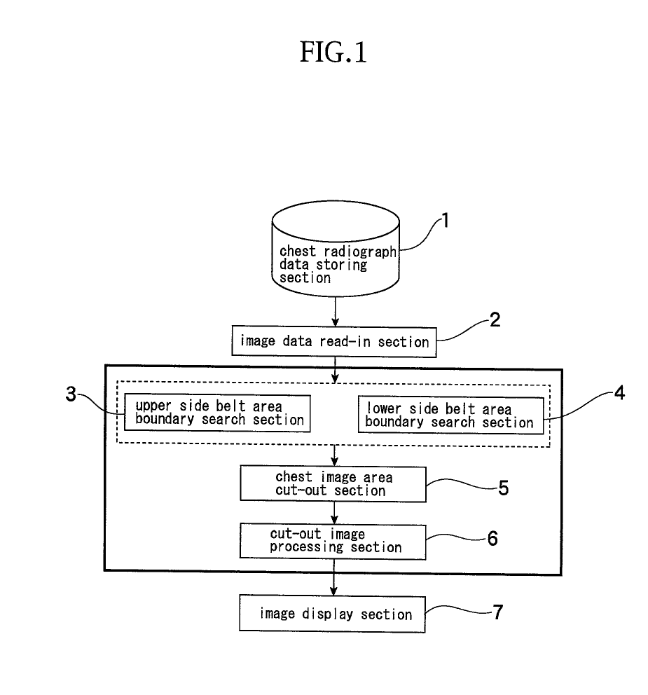

With reference to FIG. 1, an apparatus for cutting out a chest image area from an image including a belt-shape area or areas comprises an image data storing section 1 for storing a chest radiograph data, a image data read-in section 2, a belt area boundary search section including at least one of upper side belt area boundary search section 3 and lower side belt area boundary search section 4, a chest image area cut-out section 5, an image processing section 6 and an image display section 7.

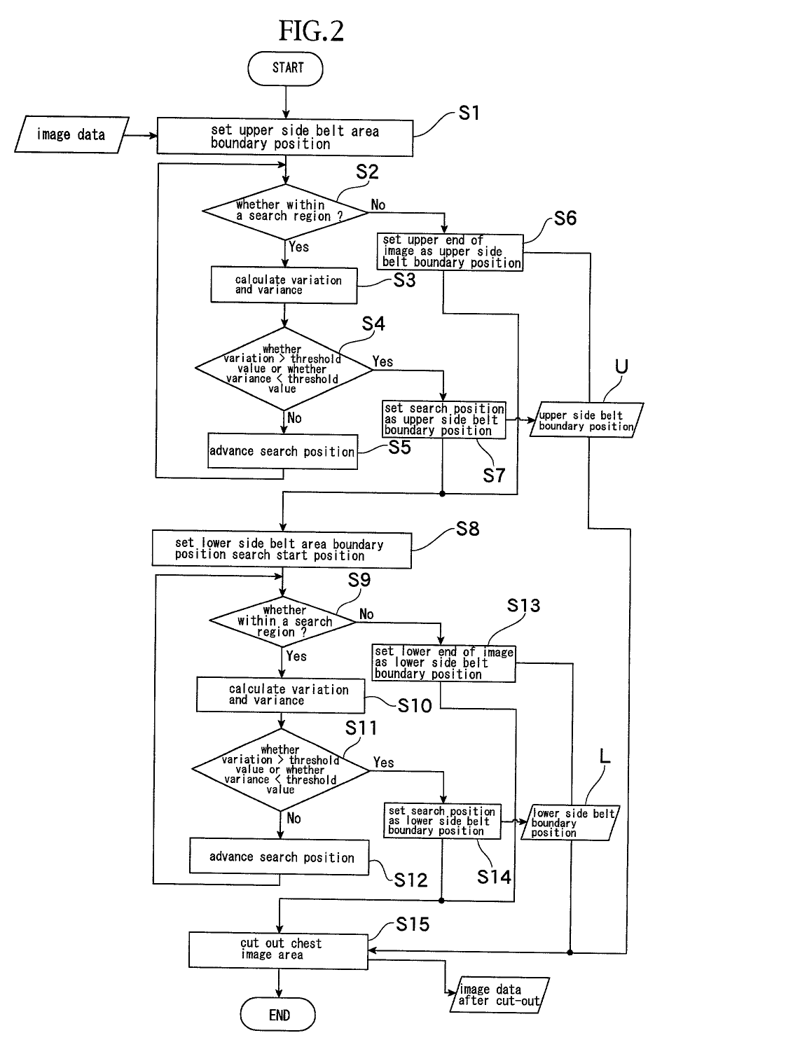

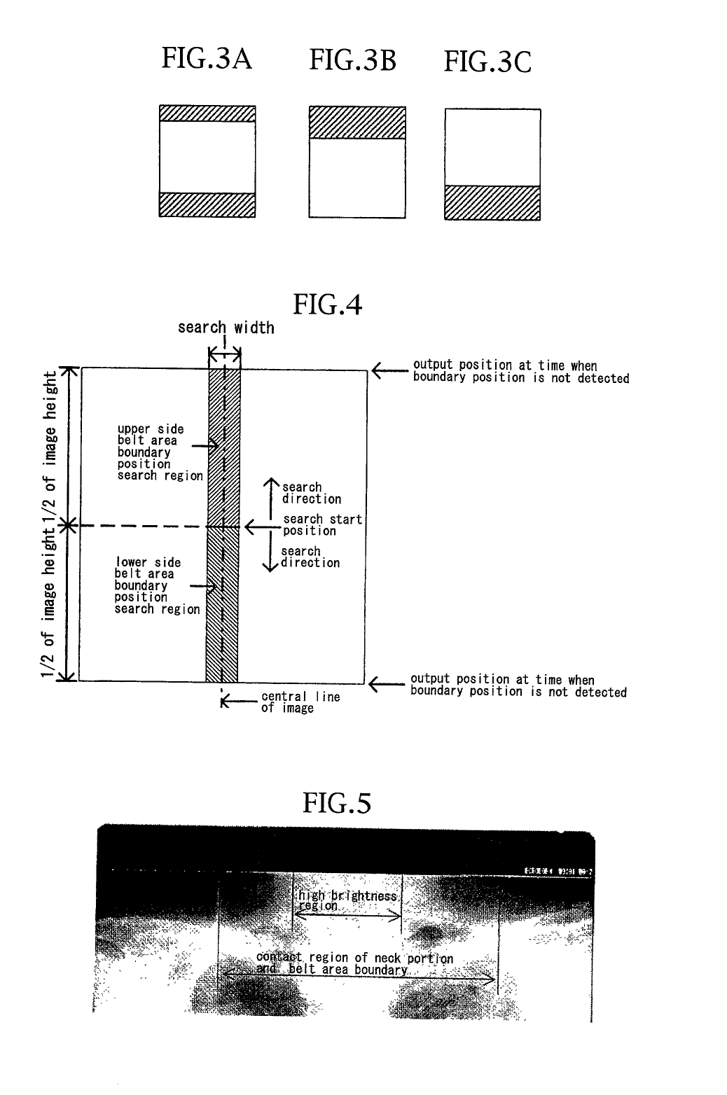

The details of the chest image area cut-out apparatus of the structure mentioned above will be made more clear from the description made with reference to the flowchart of FIG. 2. Furthermore, it is to be noted that, with reference to FIG. 3, the embodiment of the present invention has been preliminarily determined to be applicable to images having black-colored belt-shape areas of three patterns shown with oblique lines in FIG. 3; that is, a pattern A including upper and lower side belt-shape areas, a pattern B including an upper side belt-shape area and a pattern C lower side belt-shape area C.

Regions (ranges) searched by the upper side belt area boundary search section 3 and the lower side belt area boundary search section 4 are shown with oblique lines in a rectangular image in FIG. 4. An ROI (region of interest) is positioned to the search regions and then moved towards upper and lower search directions from the search start position. During such searching, when the belt area boundary is detected, the searching is ended as mentioned below, and on the contrary, when any belt area is not detected in the search regions, the upper end position and/or lower end position are deemed to be search results.

Furthermore, as shown in FIG. 5, it will be necessary to determine a search width (width to be searched) to a region at which the belt area boundary and a neck portion of a person. Further, although it is preferable to arrange the search width in an area having a high brightness in this region, it may be disposed on a back born of a person, or it may be set to a 5% width of an image width.

The above operation concerning the searching of the upper side belt area boundary position and the lower side belt area boundary position will be described hereunder in accordance with the steps S1 to S15 of the flowchart of FIG. 2. It is then to be noted that since the searchings of the upper side belt area boundary position and the lower side belt area boundary position are performed in substantially the same manner, both the searchings will be made simultaneously.

Setting of Search Start Position (Steps S1 and S8)

First, a search start position is set to a preliminarily determined position. This set position may be independently set for the upper side belt area boundary position and the lower side belt area boundary position. At that time, it is necessary to set the search start position to a position on the center side position from the belt area boundary position. The search start position may be made to ½ of the height of an image as shown in FIG. 4 together with the searchings of the upper side belt area boundary position and the lower side belt area boundary position.

Determination of Whether within Search Region ?

(Steps S2 and S9)

After the search start position has been determined, the searching towards the upward or downward direction starts for searching the belt area boundary (steps S2 to S5 and S9 to S12). During the upward or downward searching operation, it is discriminated whether the searching position goes outside the searching region, and in the case of detecting to be outside the searching region, the searching operation or processing is finished.

Calculation of Variation and Variance(S3 and S10)

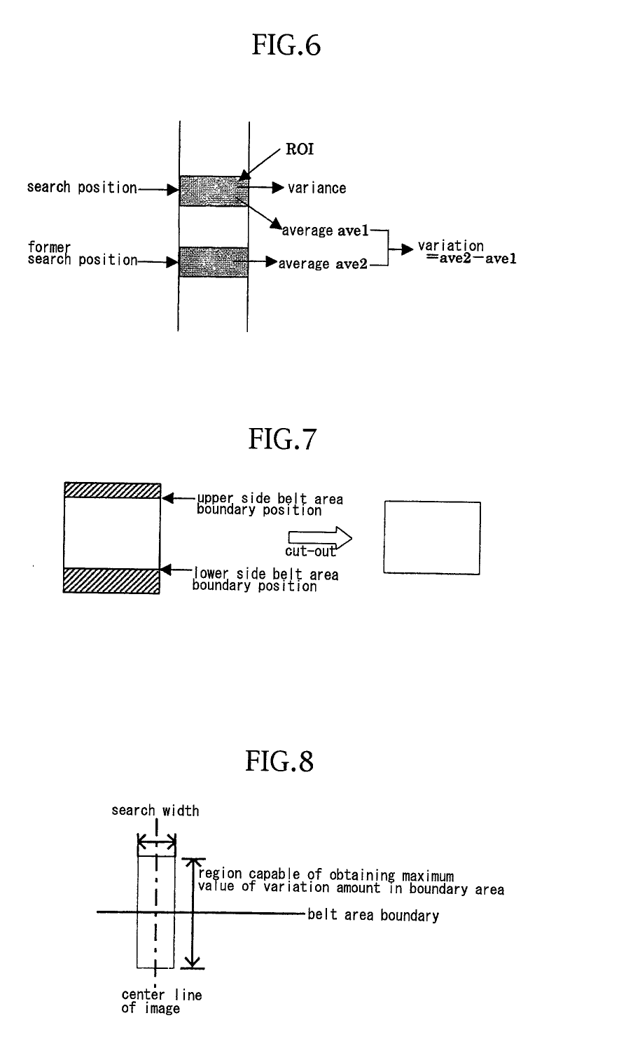

In this step S3 (S10), the variation and variance of the region of interest (ROI) set to the search position are obtained. The variation is, as shown in FIG. 6, a difference between a pixel average of the ROI set to the former search position and a pixel average of the ROI set to the present search position. Calculation equation of the variation, interval of the variation calculation and so on will be explained hereinlater.

Evaluation of Variation and Variance(S4 and S11)

In this step S4 (S11), the variation and the variance detected in the previous step S3 and S10 are evaluated. When a condition that the variation exceeds a threshold value is satisfied, the presently searching position is deemed as the belt area boundary position. On the other hand, when a condition that the variance is below a threshold value is satisfied, the presently searching position is deemed to a blank position. Further, these threshold values with respect to the variation and the variance will be also explained hereinlater.

Advancing of Search Position (S5 and S12)

In a case where the condition in the former step S4 (S11) is not satisfied, the search position advances. That is, in the case of the searching of the upper side belt area boundary position, the search position is changed to the upper side, and on the other hand, in the case of the searching of the lower side belt area boundary position, the search position is changed to the lower side.

Setting of Image Upper (Lower) End Position to

Upper (Lower) Side Belt Area Boundary Position (S6 (S13))

In the discrimination (judgement) of the step S2 (S9), when the search position is out of the search region, the belt area boundary position will be set as follows. That is, in the case of the upper side belt area boundary position search, the upper side belt area boundary position is set to the upper end position of the image, and on the other hand, in the case of the lower side belt area boundary position search, the lower side belt area boundary position is set to the lower end position of the image.

Setting of Search Position to Upper (Lower)

Side Belt Area Boundary Position (S7 (S14))

In the discrimination of the step S4 (S 11), when the variation or variance satisfies the condition, the belt area boundary position will be set as follows. That is, in the case of the upper side belt area boundary position search, the upper side belt area boundary position is set to the search position at that time, and on the other hand, in the case of the lower side belt area boundary position search, the lower side belt area boundary position is set to the search position at that time.

Cutting-out of Chest Image Area (S15)

Data relating to a position disposed between the upper side boundary position and the lower side boundary position of the image data is drawn out (cut out) by utilizing the belt area boundary position set in the forgoing step S6 (S13) or S7 (S14), which will be understood with reference to FIG. 7.

The variation and the variance mentioned above will be explained hereunder in detail.

Variation

The variation is calculated by utilizing the following equation.

diff(p)=ave(p+d)−ave(p)

(a case of detecting upper side belt area boundary position)

diff(p)=ave(p−d)−ave(p)

(a case of detecting lower side belt area boundary position)

wherein a character p is a search position (Y-coordinate), d is variation calculation interval, diff (p) is a variation on the Y-coordinate p and ave (p) is a pixel average in the ROI set to the Y-coordinate p.

As mentioned above, the searching is performed from the search start position along and towards the vertical (upper and lower) search positions. In a case where the variation exceeds the threshold value during the searching operation at a certain position, this position will be deemed as the belt area boundary position.

Pixel Average

The pixel average using for the calculation of the variation mentioned above is a pixel value of the ROI. That is, the ROI has a width corresponding to a search width and a height capable of obtaining a variation sufficiently larger than that in the chest image area in the belt boundary area. In this case, the pixel may be 1 (one) pixel.

Variance

The discrimination of the variance is performed through the detection of a blank portion included in the image data at a time when a film is read out by using a film digitizer. A calculation area of the variance is the same as that of the pixel average calculation area mentioned hereinbefore. The variance in the extra area is a small value, and in the case where this value is less than a threshold value with respect to the variance, an area of this value is deemed as the extra area.

Variation Calculation Interval

The setting of the calculation interval utilized for the calculation of the variation is performed by utilizing such a property as that there is large difference between the pixel average of the chest image area in the search area and the pixel average of the belt area. For this reason, the calculation interval of the variation is set so as to make most large this difference.

This calculation interval will be concretely performed in accordance with the following three procedures.

[Procedure 1]

In consideration of an area in a search region including a belt area boundary such as shown in FIG. 8, a pixel average of the ROI on each Y-coordinate (vertical direction in FIG. 8) is calculated.

[Procedure 2]

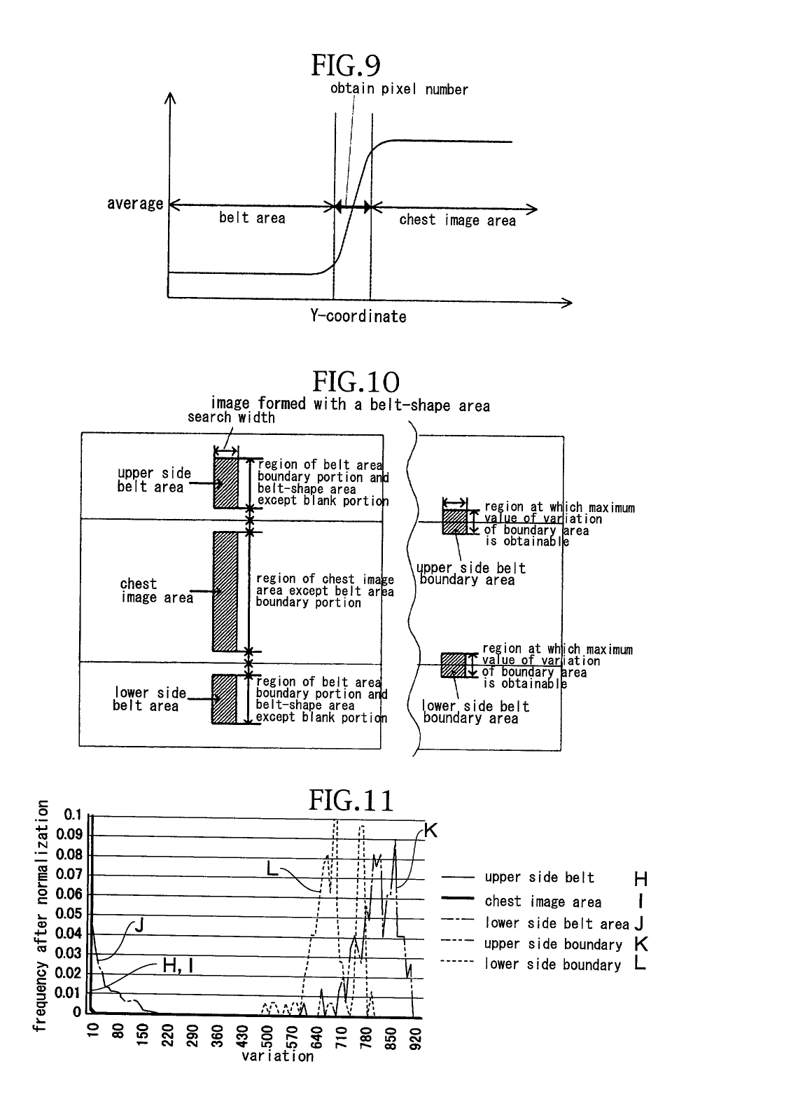

It is discriminated how many pixels are a transition from the belt area to the chest image area from the result (FIG. 9) obtained through the procedure 1.

[Procedure 3]

The result obtained through the procedure 2 is set as the variation calculation interval.

Calculation of Threshold Value to Variation

The threshold value with respect to the variation will be decided in accordance with the following procedures 1 to 3.

[Procedure 1]

Variation data of the belt area, the chest image area and the belt boundary area in the data collection region shown in FIG. 10 is collected, and it is desired to use a large number of image films to collect the data.

[Procedure 2]

A histogram is prepared by calculating the data collected for each area. However, for the data of the belt boundary area, a histogram is prepared by collecting and calculating only the maximum value of the variation in each of the upper and lower side belt boundary areas.

[Procedure 3]

The following portion is determined as a threshold value. That is, a portion, at which a histogram of the belt area and the chest image area and a histogram of the belt boundary area are made so as to approach a normal distribution and at which an erroneous classification proberbility of the distribution is made to be minimum, is determined to be the threshold value.

Otherwise, in a case where the histogram data distribution of the belt area and the chest image area and the histogram data distribution of the belt boundary area are clearly separated (not overlapped) from each other, an intermediate value between A and B (A: maximum variation in the histogram data of the belt area and the chest image area and B: minimum variation B in the histogram data of the belt boundary area) may be set as the threshold value in the case of A<B.

FIG. 11 shows one concrete example of the histogram prepared for the setting of the threshold value, in which frequencies of the respective histograms are normalized and summarized so that the total frequency becomes 1.

In a case where the belt boundary is detected in the vertical direction from the central portion of the image, it is necessary for the threshold value to be set to have a value larger than the maximum value of the variation value of the chest image area and the upper and lower belt areas. Accordingly, the threshold value is determined as follows.

Dmax*=252.7

Dmin*=501.4

Threshold=(Dmax+Dmin)/2

Threshold≈380

*Dmax: maximum variation in lower side belt area (maximum variation in histogram data of upper side belt boundary area, chest image area and lower belt boundary area)

*Dmin: minimum variation in lower side belt area (minimum variation in histogram data of upper side belt boundary area and lower belt boundary area)

Threshold: threshold value

Calculation Method of Threshold Value to Variance]

The blank portion other than the film is discriminated with reference to the variance. The threshold value with respect to the variance utilized for this discrimination will be determined in accordance with the following procedures 1 and 2.

[Procedure 1]

The variance in the chest image area in the belt area boundary search region (oblique line portion in FIG. 4) is calculated, but the blank portion other than the film portion is omitted. Further, it is desirable to use samples as much as possible.

[Procedure 2]

A value smaller than the minimum value of the variance, which is obtained by the above procedure 1, is deemed to be a threshold value with respect to the variance.

The threshold value thus obtained is not one for discriminating the belt area and the blank portion other than the film portion. In the case where the variance is smaller than the threshold value, the search position at that time is the belt area or blank portion other than the film portion.

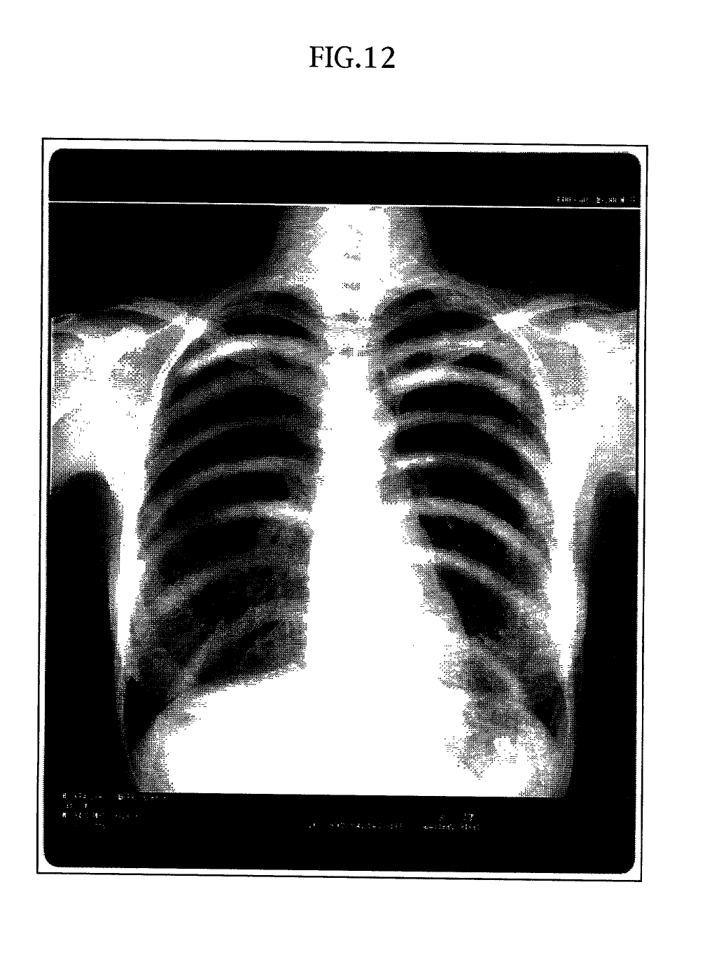

Next, a chest image area to be actually cut out is explained with reference to an example represented by FIGS. 12 to 14.

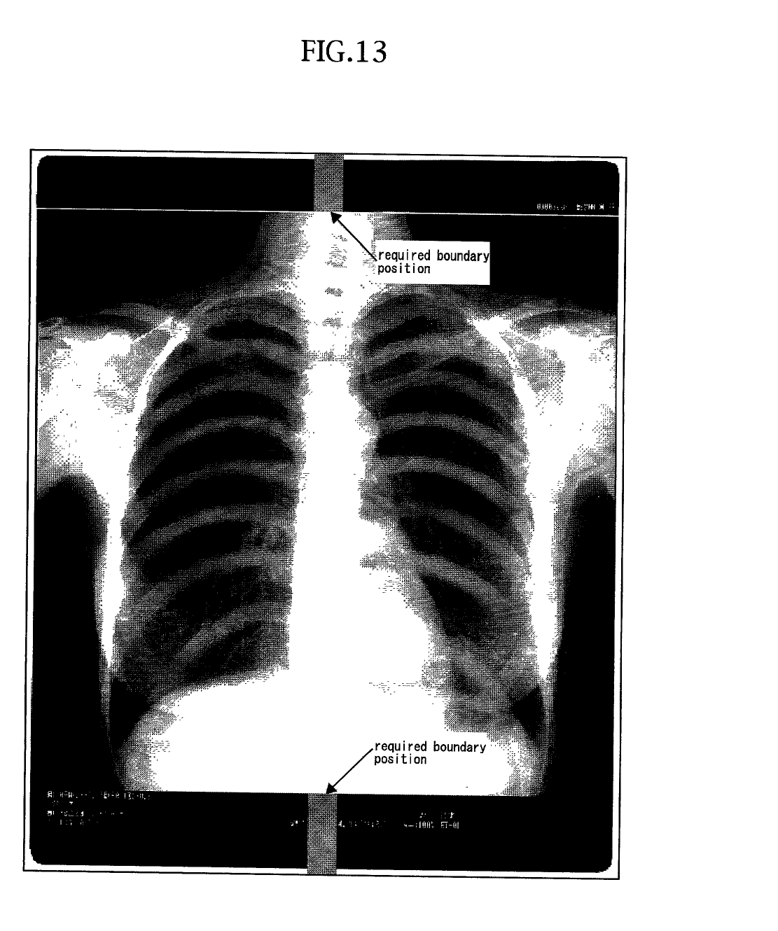

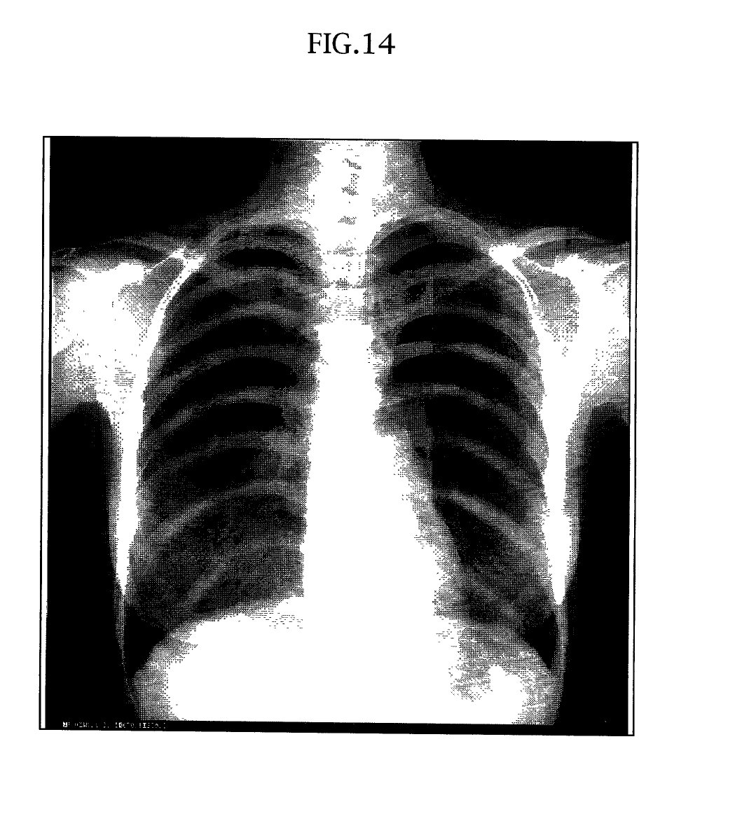

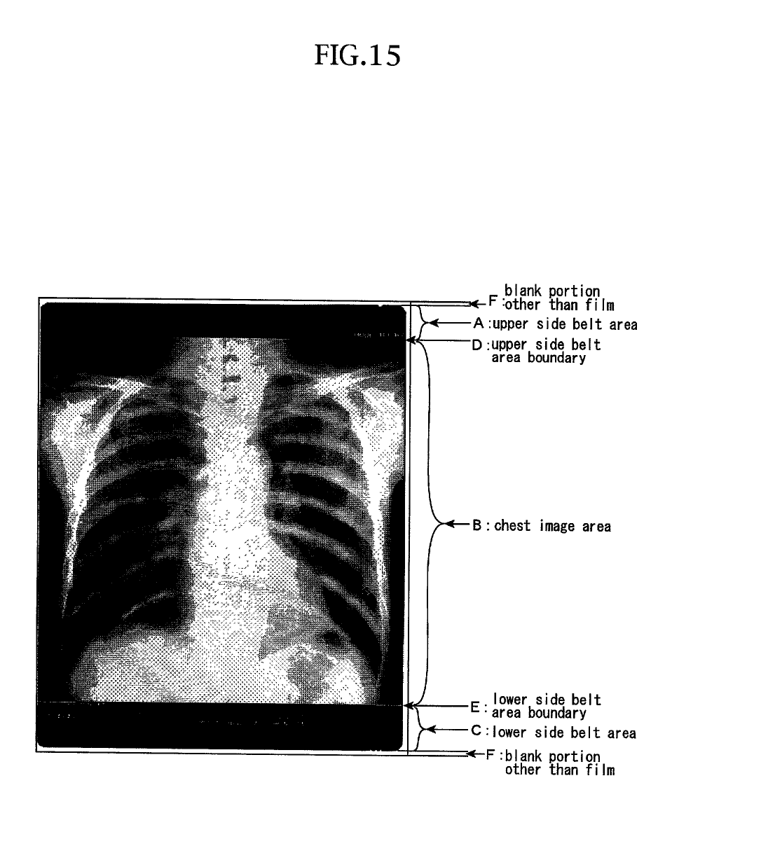

FIG. 12 is an image with belt areas before the cut-out operation. FIG. 13 is an image showing the discrimination result of the belt area boundary position, in which a gray-color area is shown on the image from the obtained upper (lower) side belt area boundary position to the upper (lower) end of the image. FIG. 14 shows an image after the cut-out operation. Further, in this example, the image is outputted so as to provide a square shape at the outputting time (that is, the image height is determined in accordance with the image width), and then, a portion of the lower side belt area remains.

According to the present invention mentioned above, chest image area can be automatically cut out from a chest radiograph. This cut-out operation can be surely performed and manual working therefor can be effectively eliminated.

Further, it is to be noted that although, in the described embodiment, the chest image area is discussed as designated area to be cut out, the present invention is not limited to this image portion and other image area of a person may be treated substantially in the same manner as that mentioned hereinbefore.

What is claimed is

1. A method of cutting out a designated area from an image formed with a belt-shape area, comprising the steps of:
searching a region of interest (ROI) from substantially a central portion of an image along and towards vertical directions;
calculating a pixel average of the ROI and a variation thereof;
detecting a belt area boundary portion between the designated area and a belt-shape area in accordance with the variation of the pixel average so as to obtain vertically upper and lower side belt area boundary portions; and
cutting out an image data, between the detected vertically upper and lower side belt area boundary portions, as a designated area data.

2. A method of cutting out a designated area from an image formed with a belt-shape area according to claim 1, further comprising the steps of calculating a variance of the ROI and detecting a blank portion of the image formed with the belt-shape area in accordance with the variance and wherein a position of the blank portion is processed as either one of the upper and lower side belt area boundary portions.

3. A method of cutting out a designated area from an image formed with a belt-shape area according to claim 1, wherein said designated area is a chest area of a person.

4. An apparatus for cutting out a designated area from an image formed with a belt-shape area, comprising:
an image data storing section for storing a chest radiograph data of a designated area of a person;
a read-in section for reading the image data from the image data storing section;
a belt area boundary search section including at least one of upper and lower side belt area boundary search sections for detecting a belt area boundary portion between the designated area and a belt-shape area;
a cut-out section for cutting out an image data as a designated area data from an information of an image data of the belt area boundary portion from the belt area boundary search section; and
a processing section for processing the image data of the cut-out designated area.

5. An apparatus for cutting out a designated area from an image formed with a belt-shape area according to claim 4, wherein said belt area boundary search section including a sensor for detecting a blank portion of the image formed with the belt-shape area.

6. An apparatus for cutting out a designated area from an image formed with a belt-shape area according to claim 5, wherein said detection of the blank portion is performed in accordance with a variance of a region of interest (ROI).

7. An apparatus for cutting out a designated area from an image formed with a belt-shape area according to claim 4, wherein said designated area is a chest area of a person.

8. An apparatus for cutting out a designated area from an image formed with a belt-shape area according to claim 4, wherein the belt area boundary portion search is performed in accordance with a variation of a pixel average of a region of interest (ROI).

9. An apparatus for cutting out a designated area from an image formed with a belt-shape area according to claim 4, further comprising an image display section for displaying a processed image from the image processing section.
